(19) United States
(12) Patent Application Publication
(10) Pub. No.: US 2013/0223828 A1
(43) Pub. Date: Aug. 29, 2013

(54) WATERPROOF STRUCTURE FOR CAMERA

(71) Applicant: SANYO Electric Co., Ltd., (US)

(72) Inventor: Yukio Enomoto, Daito-shi (JP)

(73) Assignee: SANYO Electric Co., Ltd., Osaka (JP)

(21) Appl. No.: 13/770,674

(22) Filed: Feb. 19, 2013

(30) Foreign Application Priority Data
Feb. 27, 2012 (JP) 2012-039845

(51) Int. Cl. G03B 17/08

(52) U.S. Cl. CPC G03B 17/08
USPC 396/27

(57) ABSTRACT

In a camera according to the present invention, a lens barrel is detachably attached to a camera body, and a waterproof case accommodating the lens barrel therein is detachably attached to the camera body. A locking/unlocking mechanism locks and unlocks the lens barrel and the waterproof case. The locking/unlocking mechanism includes a lens barrel lock pin and a case lock pin disposed on the camera body, a pin hole formed in the lens barrel and into which the lens barrel lock pin can be fitted, another pin hole formed in the waterproof case and into which the case lock pin can be fitted, an unlocking button disposed on the camera body, and a relay mechanism which allows both the lock pins to retract individually and which retracts both the lock pins in accordance with an unlocking operation of the unlocking button.

### CROSS-REFERENCE TO RELATED APPLICATIONS

The present application claims priority to Japanese Patent Application No. 2012-039845. The entirety of Japanese Patent Application No. 2012-039845 is incorporated by reference herein.

### BACKGROUND OF THE INVENTION

1. Field of the Invention

The present invention relates to a waterproof structure for a camera in which a lens barrel is detachably attached to a camera body, such as a camera including a retractable lens barrel, a single-lens reflex camera and a mirrorless interchangeable lens camera.

2. Description of Related Art

To realize waterproof or dripproof (hereinafter “waterproof”) of the camera, it is conventionally proposed to waterproof a casing configuring a camera body and a lens barrel.

However, in such a camera, although shooting is carried out while exchanging a plurality of lens barrels in accordance with a shooting scene, it is necessary to use special lens barrels having waterproof structures as the plurality of lens barrels, and there is a problem that general versatility of the lens barrels is poor.

Hence, it has been proposed to waterproof a camera by a rubber waterproof case accommodating the entire camera in which a lens barrel is detachably attached to a camera body.

According to such a waterproof case, even if a camera includes a general lens barrel having no waterproof structure, it is possible to waterproof the camera.

However, according to the waterproof structure for a camera using the rubber waterproof case, since an outer shape and a size of the camera body differ depending upon a camera model, it is necessary to prepare a waterproof case having different outer shape and size for every camera model. Further, it is necessary to take out the camera from the waterproof case at the time of shooting on the ground where waterproof is unnecessary, but there is a problem that this operation is troublesome.

Hence, it is an object of the present invention to provide a waterproof structure for a camera in which it is possible to waterproof a camera including a general lens barrel having no waterproof structure is attached and a troublesome operation is unnecessary at the time of a normal shooting operation requiring no waterproof.

### SUMMARY OF THE INVENTION

In a camera according to the invention, a lens barrel is detachably attached to a camera body and it is possible to attach the lens barrel to a camera body by rotating the lens barrel in a first direction.

A waterproof case which can accommodate a lens barrel is detachably attached to the camera body, and the waterproof case can be attached to the camera body by rotating the waterproof case in a second direction which is opposite from the first direction.

The lens barrel and the waterproof case can be locked to and unlocked from the camera body by a locking/unlocking mechanism.

The waterproof case includes a cylindrical case body having a waterproof structure, and an annular seal portion surrounding a cylindrical shaft of the case body is provided on a bonding portion of the case body where the camera body is bonded.

The locking/unlocking mechanism includes

a lens barrel lock pin which is disposed on a bonding surface of the camera body with respect to the lens barrel such that the lens barrel lock pin can project and retract and which is biased in a projecting direction,

a case lock pin which is disposed on a bonding surface of the camera body with respect to the waterproof case such that the case lock pin can project and retract and which is biased in the projecting direction,

a pin hole which is formed in a bonding surface of the lens barrel with respect to the camera body, and into which a tip end of the lens barrel lock pin can be fitted,

another pin hole which is formed in a bonding surface of the waterproof case with respect to the camera body, and into which a tip end of the case lock pin can be fitted,

an unlocking button disposed on the camera body, and

a relay mechanism which allows the lens barrel lock pin and the case lock pin to retract individually and which retracts, at the same time, both the lock pins in accordance with an unlocking operation of the unlocking button.

### BRIEF DESCRIPTION OF THE DRAWINGS

FIG. 1 is a perspective view showing an embodiment of a camera according to the present invention;

FIG. 2 is a vertical sectional view of the camera;

FIG. 3 is a perspective view showing a state where a waterproof case is detached from the camera;

FIG. 4 is a perspective view of a camera body to which a lens barrel is attached;

FIG. 5 is a perspective view showing a state where the lens barrel is detached from the camera body;

FIG. 6 is an exploded perspective view of the waterproof case;

FIG. 7 is an enlarged sectional view of a first seal portion in the camera;

FIG. 8 is an enlarged sectional view of a second seal portion in the camera;

FIG. 9 is a horizontal sectional view of the camera;

FIG. 10 is an enlarged sectional view of a portion A in FIG. 9;

FIG. 11 is a perspective view showing a locking/unlocking mechanism provided in a cabinet front portion of the camera body;

FIG. 12 is an exploded perspective view of the locking/unlocking mechanism and a lens barrel bonding portion of the camera body as viewed from a rear surface side of the cabinet front portion;

FIG. 13 is an exploded perspective view of the locking/unlocking mechanism as viewed from a front surface side of the cabinet front portion; and

FIG. 14 is an exploded perspective view of the lens barrel bonding portion of the camera body as viewed from the front surface side of the cabinet front portion.

### DETAILED DESCRIPTION OF THE PREFERRED EMBODIMENT

An embodiment in which the present invention is applied to a digital camera will be described specifically along the drawings. In the following description, a shooting direction of the digital camera is called front or forward and an opposite direction is called rear or back.

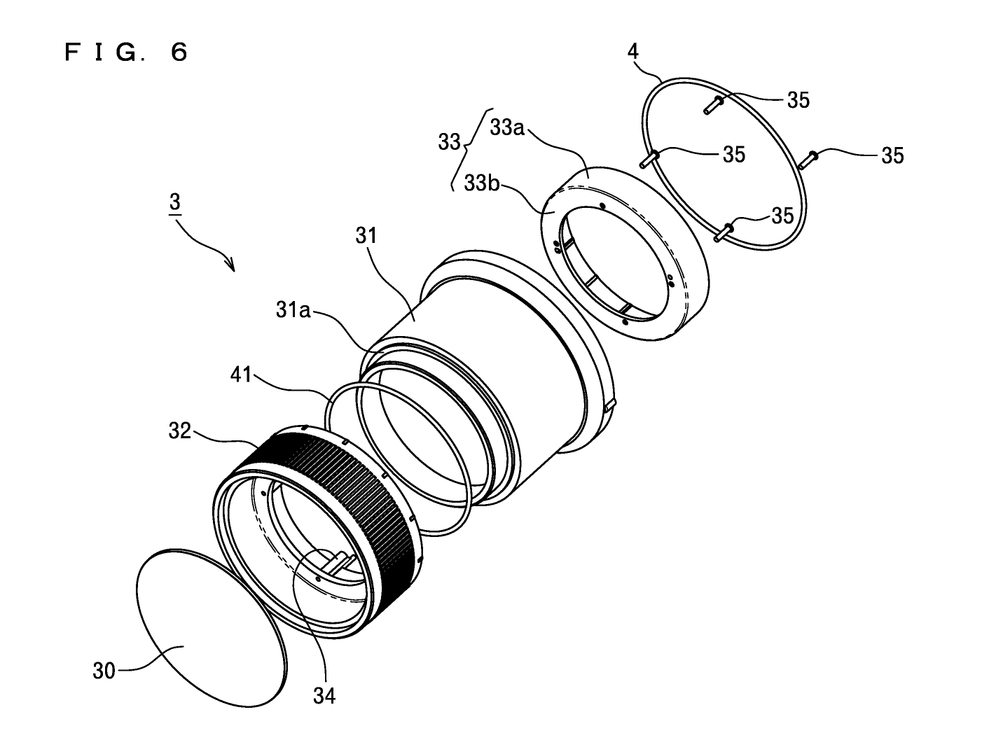

As shown in FIGS. 4 and 5, a digital camera which is an embodiment of the present invention includes a camera body 1 and a lens barrel 2 detachably attached to a cabinet front portion 12 of the camera body 1. As shown in FIGS. 1 to 3, the digital camera also includes a waterproof case 3 which is detachably attached to the cabinet front portion 12 of the camera body 1 and in which the lens barrel 2 is accommodated.

As shown in FIG. 5, a shooting window 16 through which a light beam from the lens barrel 2 is taken into the camera body 1 opens at the cabinet front portion 12 of the camera body 1. A lens barrel fixing ring 5 which surrounds the shooting window 16 to attach the lens barrel 2, and a case fixing ring 6 for attaching the waterproof case 3 are disposed on the cabinet front portion 12.

An unlocking button 11 which is operated when detaching the lens barrel 2 and the waterproof case 3 from the camera body 1 is disposed on the cabinet front portion 12 of the camera body 1.

A casing configuring the camera body 1 (excluding shooting window 16) has a waterproof structure. Known structures which are conventionally used for casings of various kinds of electronic devices can be employed as the waterproof structure.

The lens barrel 2 includes a fixed lens barrel portion 21 which should be detachably attached to the lens barrel fixing ring 5 of the camera body 1, a movable lens barrel portion 22 which is disposed coaxially with the fixed lens barrel portion 21 and which can reciprocate along a cylindrical shaft of the fixed lens barrel portion 21, and a zoom ring 23 which is rotatably disposed coaxially with the fixed lens barrel portion 21. The movable lens barrel portion 22 reciprocates in connection with rotation of the zoom ring 23.

An outer peripheral surface of the zoom ring 23 is formed of cylindrical resilient member so that the zoom ring 23 can easily be rotated and operated by friction resistance caused when a finger is put on the outer peripheral surface.

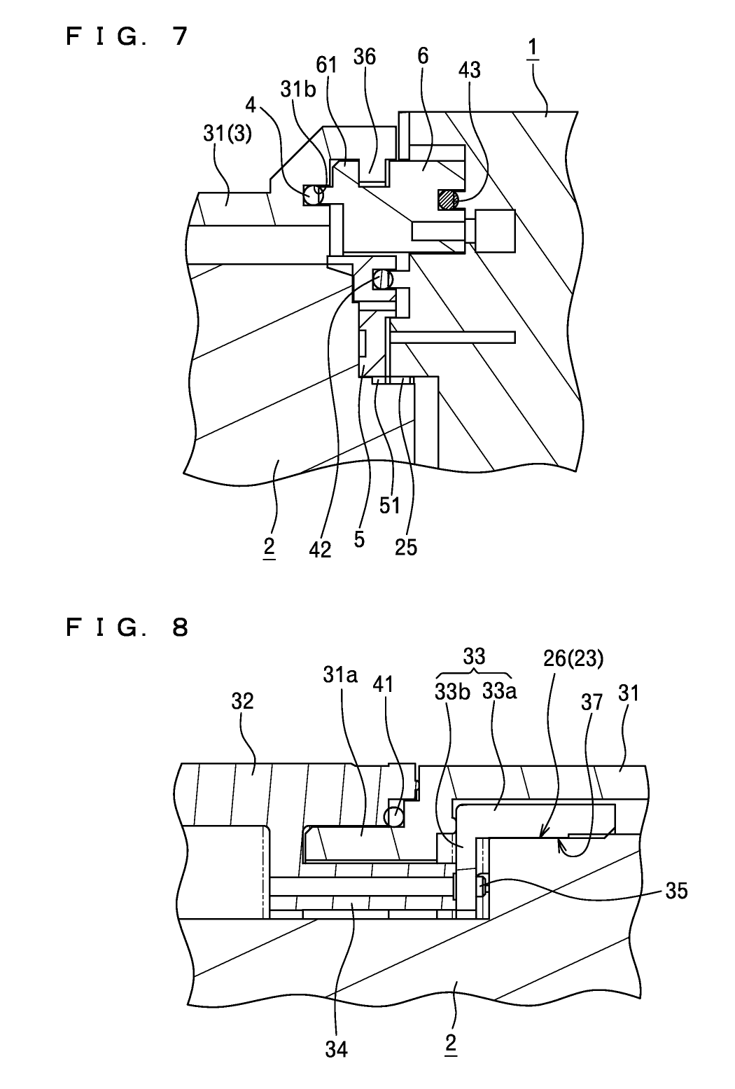

An O-ring 42 shown in FIG. 7 is fitted into a recess formed in an opposed surface of the fixed lens barrel portion 21 which is opposed to the camera body 1.

In the lens barrel 2, a zoom adjustment can be carried out by rotating the zoom ring 23.

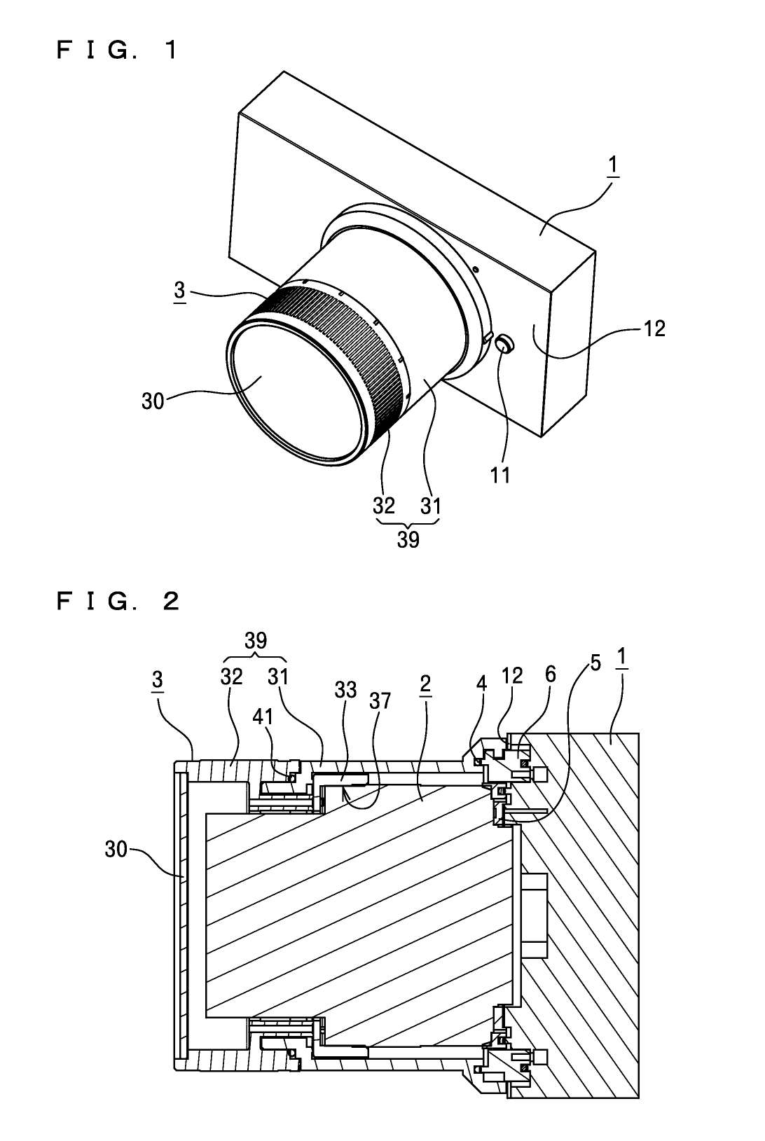

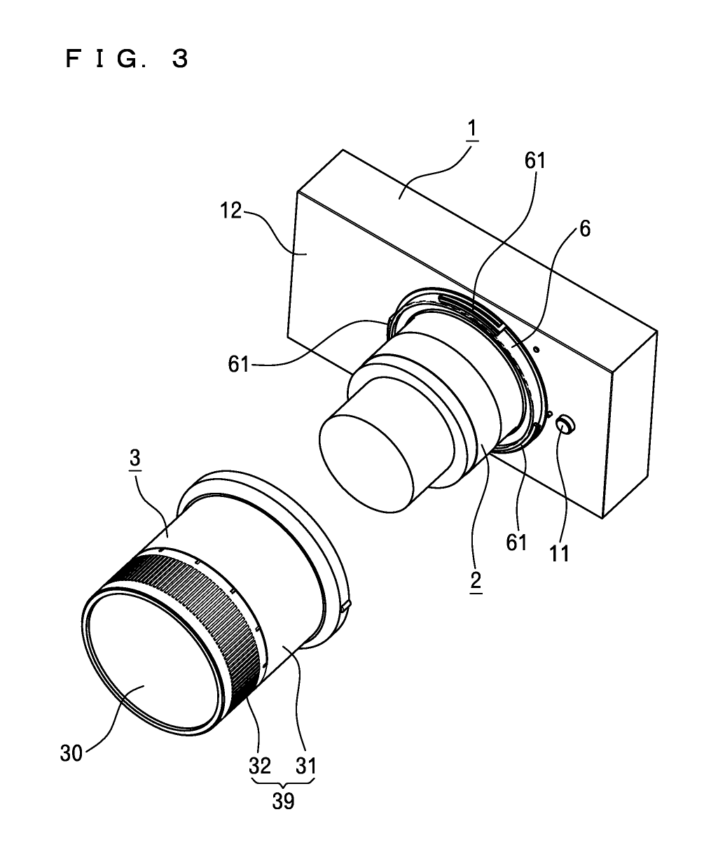

As shown in FIG. 2, the waterproof case 3 includes a cylindrical case body 39 in which the lens barrel 2 attached to the camera body 1 can be accommodated. The case body 39 is made of synthetic resin. The case body 39 includes a fixed cylindrical member 31 which can be detachably attached to the camera body 1, and a rotating cylindrical member 32 which is relatively rotatably connected an open end of the fixed cylindrical member 31 coaxially with the fixed cylindrical member 31. A transparent plate 30 is adhered and fixed to a front open end of the rotating cylindrical member 32.

As shown in FIGS. 6 and 8, a ring member 33 made of synthetic resin is fitted into the fixed cylindrical member 31 configuring the waterproof case 3. The ring member 33 includes a cylindrical portion 33a and a disk portion 33b. The ring member 33 is fastened to the rotating cylindrical member 32 by screwing four screws 35 from the disk portion 33b into bosses 34 of the rotating cylindrical member 32.

A front end portion 31a of the fixed cylindrical member 31 is sandwiched between a rear end of the rotating cylindrical member 32 and the ring member 33 under pressure. According to this configuration, the fixed cylindrical member 31 and the rotating cylindrical member 32 are relatively rotatably and coaxially connected to each other.

A cylindrical surface-shaped engaging surface 37 which should be brought into contact, under pressure, with an outer peripheral surface 26 of the zoom ring 23 of the lens barrel 2 is formed on an inner peripheral surface of the cylindrical portion 33a of the ring member 33. The outer peripheral surface 26 of the zoom ring 23 and the engaging surface 37 of the ring member 33 are formed into tapered surfaces whose diameters are slightly reduced forwardly. An outer diameter of the outer peripheral surface 26 of the zoom ring 23 is slightly greater than an inner diameter of the engaging surface 37 of the ring member 33.

A plurality of protruding portions (not shown) extending in the cylindrical shaft direction of the ring member 33 is formed on the engaging surface 37 of the ring member 33. The outer peripheral surface 26 of the zoom ring 23 is slightly resiliently deformed by bringing the engaging surface 37 into contact with the outer peripheral surface 26 of the zoom ring 23 under pressure. The outer peripheral surface 26 of the zoom ring 23 and the engaging surface 37 of the ring member 33 are in contact with each other under pressure while creating friction resistance. As the rotating cylindrical member 32 rotates, the zoom ring 23 can integrally rotate.

An O-ring 41 extending to surround a front end portion 31a of the fixed cylindrical member 31 is provided on a bonding portion between the fixed cylindrical member 31 and the rotating cylindrical member 32 of the waterproof case 3. The O-ring 41 is sandwiched between the fixed cylindrical member 31 and the rotating cylindrical member 32 under pressure. The O-ring 41 configures a seal portion (second seal portion) which waterproofs between the fixed cylindrical member 31 and the rotating cylindrical member 32.

While the rotating cylindrical member 32 rotates with respect to the fixed cylindrical member 31, the O-ring 41 slides on any of cylindrical members, and allows the rotating cylindrical member 32 to rotate while keeping the waterproof ability.

The fixed cylindrical member 31 configures the waterproof case 3. As shown in FIGS. 6 and 7, an O-ring 4 extending to surround the cylindrical shaft of the fixed cylindrical member 31 is fitted into an annular recess portion 31b formed in a surface of the fixed cylindrical member 31 which is opposed to the camera body 1.

As shown in FIG. 5, three engaged ribs 51, 51, 51 extending on an arc at intervals of 120° phase angle from one another project on the lens barrel fixing ring 5. As shown in FIG. 7, three engaging ribs 25, 25, 25 extending on an arc project on the fixed lens barrel portion 21 of the lens barrel 2 at positions corresponding to the engaged ribs 51, 51, 51 of the lens barrel fixing ring 5.

The fixed lens barrel portion 21 of the lens barrel 2 is pressed against the lens barrel fixing ring 5, the fixed lens barrel portion 21 is rotated and screwed in the counterclockwise direction, and the engaging ribs 25, 25, 25 are respectively engaged with the engaged ribs 51, 51, 51. According to this operation, the lens barrel 2 can be detachably attached to the camera body 1.

This configuration is the same as a configuration for detachably attaching a lens barrel in a conventional camera.

By attaching the lens barrel 2 to the camera body 1, the O-ring 42 disposed on the lens barrel 2 is sandwiched between the fixed lens barrel portion 21 of the lens barrel 2 and the camera body 1 under pressure, and the seal portion is configured between the lens barrel 2 and the camera body 1 by the O-ring 42.

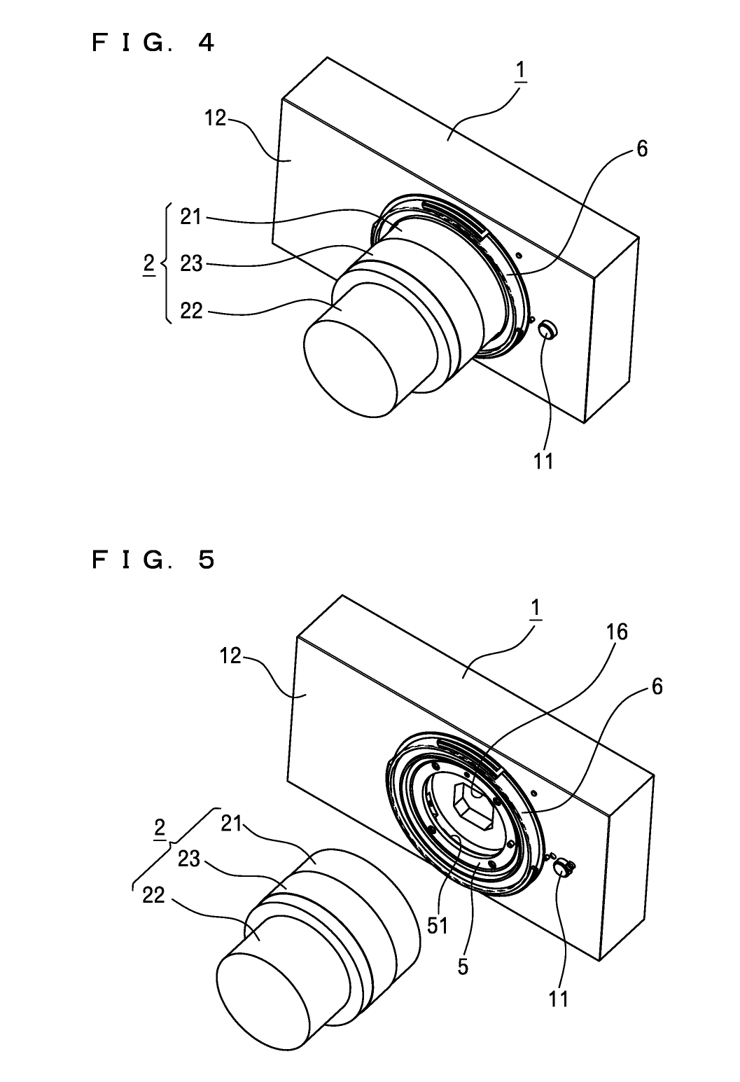

As shown in FIG. 3, three engaged ribs 61, 61, 61 extending on an arc at intervals of 120° phase angle from one another project on the case fixing ring 6. As show in FIG. 7, three engaging ribs 36, 36, 36 extending on an arc project on the fixed cylindrical member 31 of the waterproof case 3 at positions corresponding to the engaged ribs 61, 61, 61 of the case fixing ring 6.

The fixed cylindrical member 31 of the waterproof case 3 is pressed against the case fixing ring 6, the fixed cylindrical member 31 is rotated and screwed in the clockwise direction, and the engaging ribs 36, 36, 36 are respectively engaged with the engaged ribs 61, 61, 61. According to this operation, the waterproof case 3 can be detachably attached to the camera body 1.

This configuration is the same as a configuration for detachably attaching the lens barrel 2 to the camera body 1.

By attaching the waterproof case 3 to the camera body 1, the O-ring 4 is sandwiched between the fixed cylindrical member 31 of the waterproof case 3 and the case fixing ring 6 under pressure, and a seal portion (first seal portion) is configured between the fixed cylindrical member 31 and the case fixing ring 6 by the O-ring 4.

An O-ring 43 is interposed between the camera body 1 and the case fixing ring 6, and a seal portion is configured between the camera body 1 and the case fixing ring 6 by the O-ring 43.

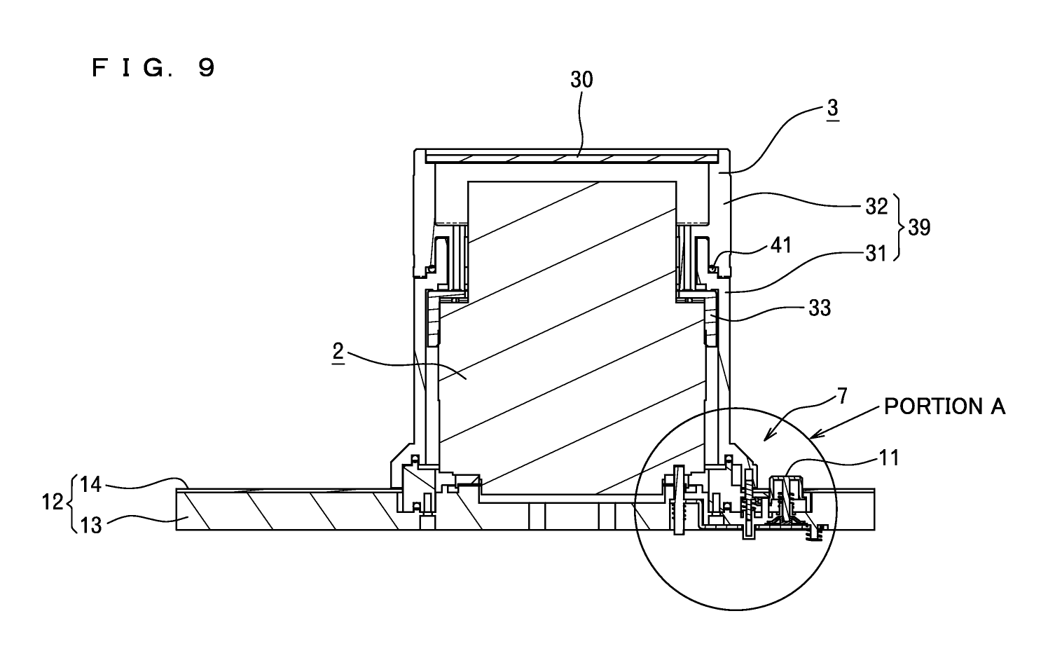

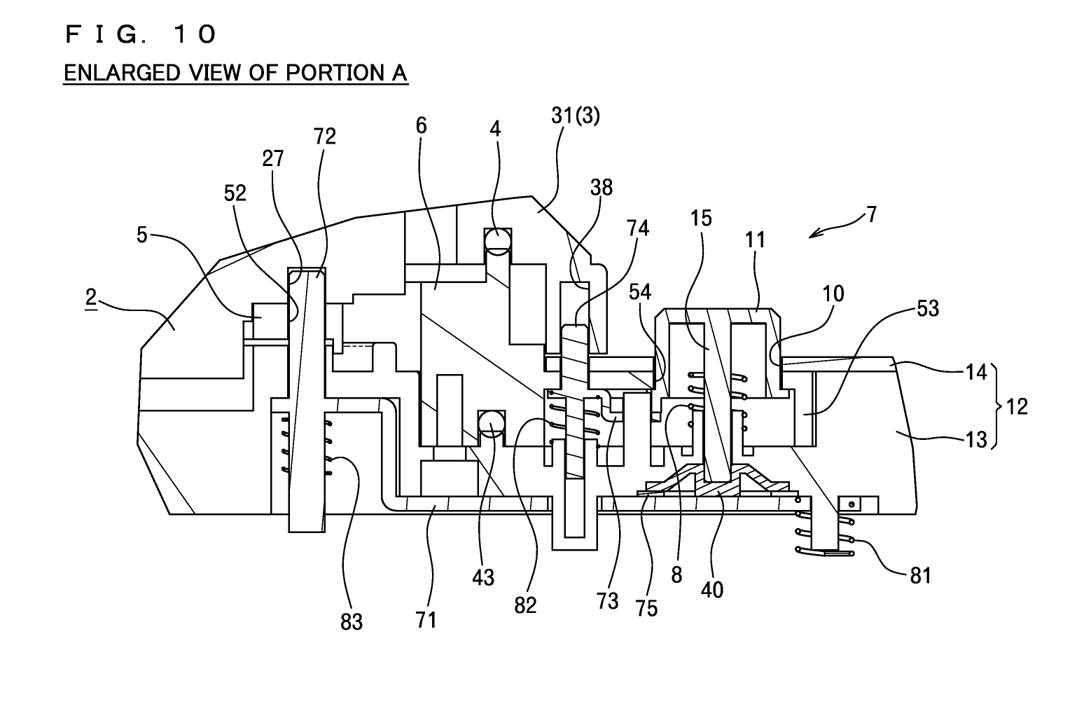

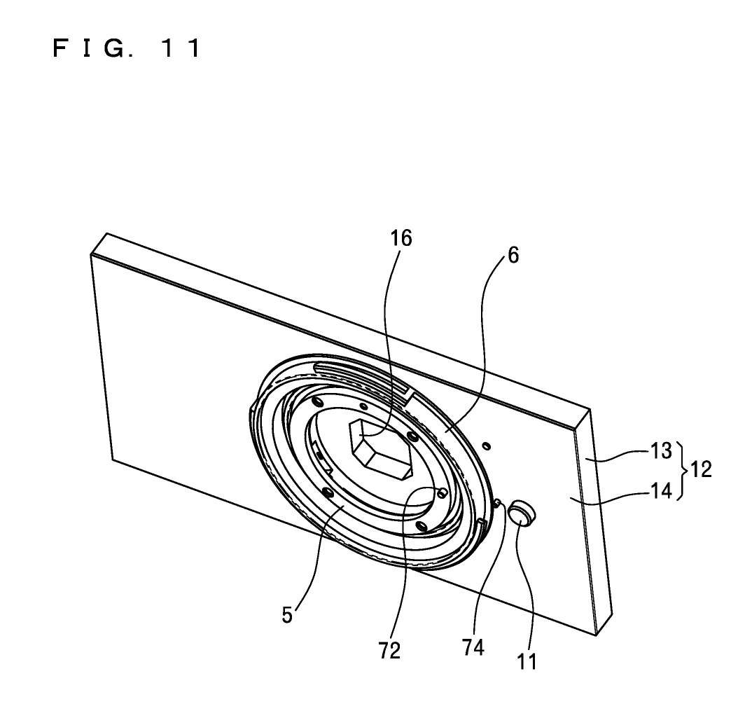

As shown in FIG. 9, a locking/unlocking mechanism 7 is disposed on a bonding portion between the cabinet front portion 12, the lens barrel 2 and the waterproof case 3. The locking/unlocking mechanism 7 locks the lens barrel 2 and the waterproof case 3 in their attached state, or unlocks the lens barrel 2 and the waterproof case 3.

As shown in FIGS. 10 to 14, the locking/unlocking mechanism 7 includes a lens barrel lock pin 72 which is disposed on a bonded surface of the lens barrel fixing ring 5 with respect to the lens barrel 2 such that the lens barrel lock pin 72 can project and retract and which is biased in a projecting direction by a spring 83, a case lock pin 74 which is disposed on a bonded surface of the case fixing ring 6 with respect to the waterproof case 3 such that the case lock pin 74 can project and retract and which is biased in a projecting direction by a spring 82, and a pin hole 27 which is formed in a bonded surface of the lens barrel 2 with respect to the lens barrel fixing ring 5 and into which a tip end of the lens barrel lock pin 72 can be fitted, a pin hole 38 which is formed in a bonded surface of the waterproof case 3 with respect to the case fixing ring 6 and into which a tip end of the case lock pin 74 can be fitted, the unlocking button 11 which is disposed on the camera body 1 such that the unlocking button 11 can be pushed down and which is biased in a projecting direction by a spring 8, a first movable member 71 interposed between the unlocking button 11 and the lens barrel lock pin 72, and a second movable member 73 interposed between the unlocking button 11 and the case lock pin 74.

One end of the first movable member 71 is integrally connected to the lens barrel lock pin 72, and the other end of the first movable member 71 is opposed to a lower end surface of a shaft portion 15 of the unlocking button 11. The other end of the first movable member 71 is biased forward by a spring 81.

A disk packing 40 is interposed between a lower end of the shaft portion 15 of the unlocking button 11 and the other end of the first movable member 71. The packing 40 can resiliently be deformed in a compressing direction.

A washer piece 75 is disposed on the other end of the first movable member 71 on a surface on the side of the unlocking button 11, and the packing 40 is sandwiched between the shaft portion 15 of the unlocking button 11 and the washer piece 75 by biasing forces of the springs 83, 8 under pressure.

According to this configuration, the other end of the first movable member 71 presses the unlocking button 11 forward (in projecting direction).

One end of the second movable member 73 is integrally connected to the case lock pin 74, and the other end of the second movable member 73 is opposed to a lower end surface of an outer periphery of the unlocking button 11. The other end of the second movable member 73 is brought into contact, under pressure, with a lower end surface of the outer periphery of the unlocking button 11 by a biasing force of the spring 82.

According to this configuration, the other end of the second movable member 73 presses the unlocking button 11 forward (in projecting direction).

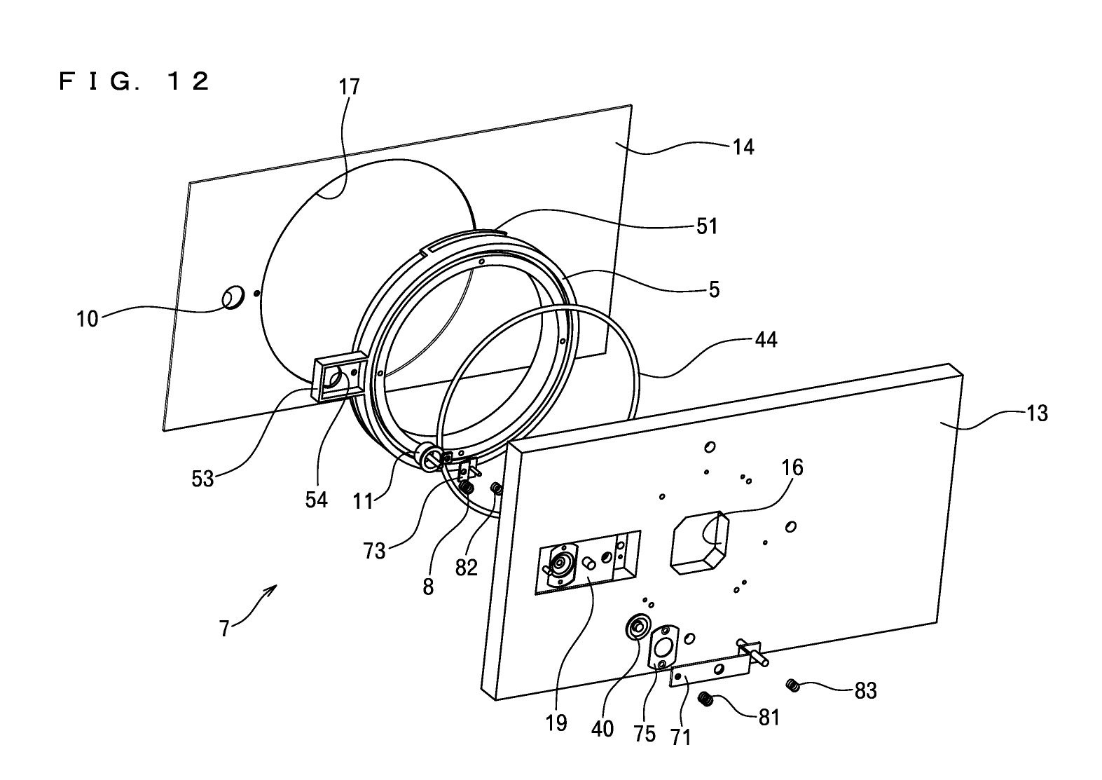

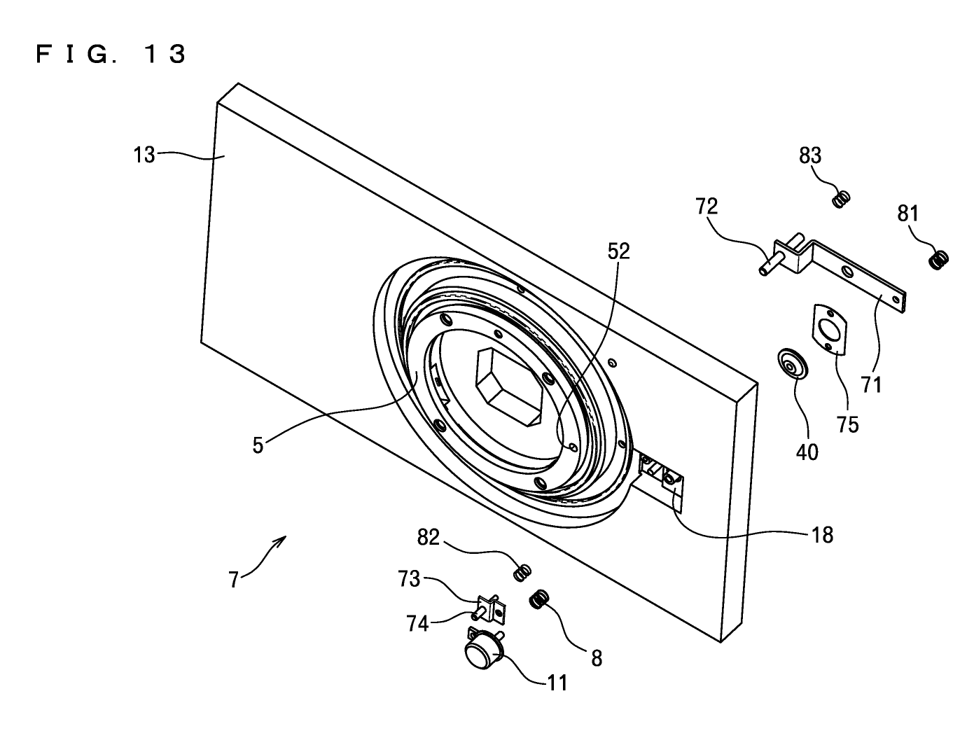

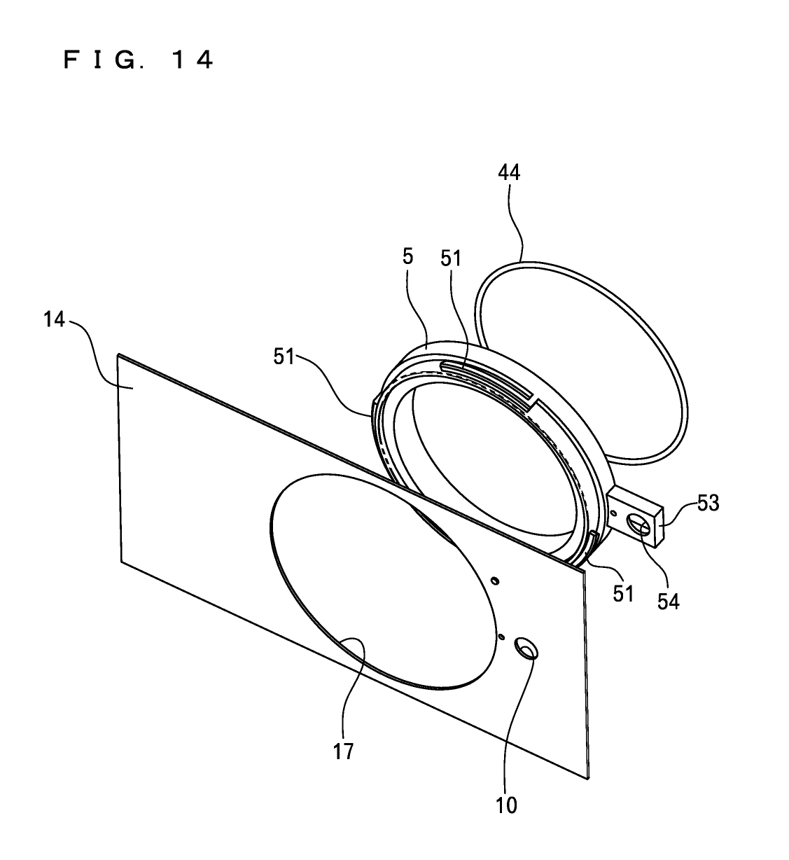

As shown in FIG. 11, the cabinet front portion 12 has a laminated structure including a first plate 13 and a second plate 14. As shown in FIG. 12, an attaching portion 19 for the packing 40, the washer piece 75, the first movable member 71 and the springs 81 and 83 is formed in a back surface of the first plate 13 in a recessed manner. As shown in FIG. 13, an attaching portion 18 for the springs 8 and 82, the second movable member 73 and the unlocking button 11 is formed in a front surface of the first plate 13 in a recessed manner.

As shown in FIGS. 12 and 14, a circular window 17 from which a front surface of the lens barrel fixing ring 5 is exposed and a circular hole 10 from which a head of the unlocking button 11 is exposed are formed in the second plate 14, and a circular hole 54 is formed in a holding piece 53 projecting on the lens barrel fixing ring 5. A head of the unlocking button 11 penetrates through the circular hole 54.

An O-ring 44 is interposed between the lens barrel fixing ring 5 and the first plate 13.

As shown in FIG. 10, according to the locking/unlocking mechanism 7, there is a possibility that water enters from a gap between the unlocking button 11 and the cabinet front portion 12 but the packing 40 and the O-ring 43 prevent water from entering the camera body 1.

In the locking/unlocking mechanism 7, if only the lens barrel lock pin 72 is pushed toward the camera body 1, only the first movable member 71 retracts and the case lock pin 74 does not retract at the same time. If only the case lock pin 74 is pushed toward the camera body 1, only the second movable member 73 retracts and the lens barrel lock pin 72 does not retract at the same time.

If the unlocking button 11 is pressed down, the first movable member 71 and the second movable member 73 are pressed down, and according to this motion, the lens barrel lock pin 72 and the case lock pin 74 retract at the same time.

In this camera, to attach the lens barrel 2 to the camera body 1, if the lens barrel 2 is pressed against the lens barrel fixing ring 5 of the camera body 1 in a predetermined relative angle attitude, the lens barrel lock pin 72 is pressed down and retracted by the lens barrel 2.

In this state, if the lens barrel 2 is rotated about 30° in the counterclockwise direction (first direction) and is screwed into the lens barrel fixing ring 5, the lens barrel 2 is connected to the camera body 1. At this point, the lens barrel lock pin 72 of the camera body 1 is opposed to the pin hole 27 of the lens barrel 2, and the lens barrel lock pin 72 is biased by the spring 83 and fitted into the pin hole 27.

As a result, rotation of the lens barrel 2 is restrained and the lens barrel 2 is locked on the camera body 1.

Thereafter, to attach the waterproof case 3 to the camera body 1, if the waterproof case 3 is pressed against the case fixing ring 6 of the camera body 1 in a predetermined relative angle attitude, the case lock pin 74 is pressed down and retracted by the waterproof case 3. At that time, since the lens barrel lock pin 72 does not retract at the same time, the locked state of the lens barrel 2 is not released.

In this state, if the waterproof case 3 is rotated about 30° in the clockwise direction (second direction) and screwed into the case fixing ring 6, the waterproof case 3 is connected to the camera body 1. At this point, the case lock pin 74 of the camera body 1 is opposed to the pin hole 38 of the waterproof case 3, and the case lock pin 74 is biased by the spring 82 and fitted into the pin hole 38.

As a result, the waterproof case 3 is locked on the camera body 1.

Even if the lens barrel 2 receives a clockwise rotation torque when the waterproof case 3 rotates, since the lens barrel 2 is locked, the lens barrel 2 does not rotate in a loosening direction when the waterproof case 3 rotates, and the screwed lens barrel 2 does not loosen.

By attaching the lens barrel 2 and the waterproof case 3 to the camera body 1 in this manner, the lens barrel 2 is accommodated in the case body 39 of the waterproof case 3 as shown in FIG. 2.

The engaging surface 37 provided on the inner peripheral surface of the rotating cylindrical member 32 of the waterproof case 3 is brought into contact with the outer peripheral surface 26 of the zoom ring 23 of the lens barrel 2 under pressure.

In this state, if a finger is put on the rotating cylindrical member 32 of the waterproof case 3 and the rotating cylindrical member 32 is rotated around the cylindrical shaft, the zoom ring 23 rotates integrally with the rotating cylindrical member 32, this rotation reciprocates the movable lens barrel portion 22 of the lens barrel 2 with respect to the fixed lens barrel portion 21 in the cylindrical shaft direction, and the zoom adjustment is carried out.

A length of the cylindrical shaft direction of the lens barrel 2 has a margin for allowing reciprocal movement of the movable lens barrel portion 22 of the lens barrel 2.

Since the transparent plate 30 is adhered and fixed to a front open end of the rotating cylindrical member 32, water does not enter from between the rotating cylindrical member 32 and the transparent plate 30. The first seal portion using the O-ring 4 waterproofs the bonding portion between the lens barrel 2 and the camera body 1, and the second seal portion using the O-ring 41 waterproofs between the fixed cylindrical member 31 and the rotating cylindrical member 32 of the lens barrel 2.

Therefore, even if the lens barrel 2 is a general lens barrel having no waterproof structure, if the waterproof case 3 is attached, it is possible to waterproof the bonding portion between the lens barrel 2 and the camera body 1 of the lens barrel 2.

By rotating the rotating cylindrical member 32 of the waterproof case 3, the zoom ring 23 of the lens barrel 2 can be rotated through the same angle as the rotation angle of the rotating cylindrical member 32. Therefore, the zoom adjustment becomes easy.

When the waterproof case 3 is to be detached, the unlocking button 11 is pressed down. According to this movement, the lens barrel lock pin 72 and the case lock pin 74 of the camera body 1 retract at the same time, these pins are pulled out from the pin hole 27 of the lens barrel 2 and the pin hole 38 of the waterproof case 3, the locked states of the lens barrel 2 and the waterproof case 3 are released, and the lens barrel 2 and the waterproof case 3 are allowed to rotate.

In this state, if the waterproof case 3 is rotated about 30° in the counterclockwise direction, the connection of the waterproof case 3 with respect to the camera body 1 is released and the waterproof case 3 can be detached. At that time, even if the lens barrel 2 receives a counterclockwise rotation torque when the waterproof case 3 rotates, the screwed lens barrel 2 does not loosen.

Thereafter, when the lens barrel 2 is to be detached from the camera body 1, the lens barrel 2 is rotated about 30° in the clockwise direction while pressing down the unlocking button 11 of the camera body 1. According to this operation, the lens barrel 2 can be detached.

According to this camera, at the time of a normal shooting operation requiring no waterproof, the locked state of the waterproof case 3 is released by operating the unlocking button 11 and the waterproof case 3 can be detached. Therefore, the troublesome operation is unnecessary.

The locked state of the waterproof case 3 and the locked state of the lens barrel 2 are released by means of the common unlocking button 11. Therefore, the number of the unlocking buttons is reduced as compared with a case where the unlocking buttons are prepared for the waterproof case 3 and the lens barrel 2, and the configuration of the locking/unlocking mechanism 7 becomes simple.

Incidentally, the configuration of each of the constituent parts according to the present invention is not limited to those described preferred embodiment. Various changes can be made by those skilled in the art within the range not departing from the spirit of the present invention.

For example, the waterproof case 3 is not limited to the configuration including the fixed cylindrical member 31 and the rotating cylindrical member 32, and it is also possible to employ a configuration including a single cylindrical member.

What is claimed is:

1. A waterproof structure for a camera comprising:
a camera body;
a lens barrel which is detachably attached to the camera body; and
a waterproof case which is detachably attached to the camera body and which accommodates the lens barrel therein, wherein
the lens barrel is attached to the camera body by rotating the lens barrel in a first direction,
the waterproof case is attached to the camera body by rotating the waterproof case in a second direction which is opposite from the first direction,
the lens barrel and the waterproof case are locked on and unlocked from the camera body by a locking/unlocking mechanism,
the waterproof case includes a cylindrical case body which has a waterproof structure, the case body provides an annular seal portion surrounding a cylindrical shaft of the case body on a bonding portion thereof with respect to the camera body, and
the locking/unlocking mechanism includes
a lens barrel lock pin which is disposed on a bonding surface of the camera body with respect to the lens barrel such that the lens barrel lock pin projects and retracts and which is biased in a projecting direction,
a case lock pin which is disposed on a bonding surface of the camera body with respect to the waterproof case such that the case lock pin projects and retracts and which is biased in the projecting direction,
a pin hole which is recessed in a bonding surface of the lens barrel with respect to the camera body, and into which a tip end of the lens barrel lock pin is fitted,
another pin hole which is recessed in a bonding surface of the waterproof case with respect to the camera body, and into which a tip end of the case lock pin is fitted,
an unlocking button disposed on the camera body, and
a relay mechanism which allows the lens barrel lock pin and the case lock pin to retract individually and which retracts, at the same time, both the lock pins in accordance with an unlocking operation of the unlocking button.

2. The waterproof structure according to claim 1, wherein the camera body includes a casing which has a waterproof structure except a shooting window through which a light beam from the lens barrel is taken inside.

3. The waterproof structure according to claim 1, wherein the lens barrel includes a fixed lens barrel portion which is detachably attached to the camera body and a movable lens barrel portion which is disposed coaxially with the fixed lens barrel portion and which reciprocates along a cylindrical shaft of the fixed lens barrel portion, a zoom ring is disposed coaxially with the fixed lens barrel portion, and the movable lens barrel portion reciprocates in tandem with rotation of the zoom ring.

4. The waterproof structure according to claim 2, wherein the lens barrel includes a fixed lens barrel portion which is detachably attached to the camera body and a movable lens barrel portion which is disposed coaxially with the fixed lens barrel portion and which reciprocates along a cylindrical shaft of the fixed lens barrel portion, a zoom ring is disposed coaxially with the fixed lens barrel portion, and the movable lens barrel portion reciprocates in tandem with rotation of the zoom ring.

5. The waterproof structure according to claim 3, wherein the case body of the waterproof case includes a fixed cylindrical member which is detachably attached to the camera body, and a rotating cylindrical member which is relatively rotatably connected to a front opening of the fixed cylindrical member coaxially with the fixed cylindrical member, a front opening of the rotating cylindrical member is closed with a transparent plate, a bonding portion of the fixed cylindrical member with respect to the camera body is provided with an annular first seal portion which surrounds a cylindrical shaft of the case body, a bonding portion between the fixed cylindrical member and the rotating cylindrical member is provided with an annular second seal portion which surrounds the cylindrical shaft of the case body, and an inner peripheral surface of the rotating cylindrical member is provided with an engaging surface which comes into contact with an outer peripheral surface of the zoom ring of the lens barrel to rotate the zoom ring integrally with the rotating cylindrical member.

6. The waterproof structure according to claim 4, wherein the case body of the waterproof case includes a fixed cylindrical member which is detachably attached to the camera body, and a rotating cylindrical member which is relatively rotatably connected to a front opening of the fixed cylindrical member coaxially with the fixed cylindrical member, a front opening of the rotating cylindrical member is closed with a transparent plate, a bonding portion of the fixed cylindrical member with respect to the camera body is provided with an annular first seal portion which surrounds a cylindrical shaft of the case body, a bonding portion between the fixed cylindrical member and the rotating cylindrical member is provided with an annular second seal portion which surrounds the cylindrical shaft of the case body, and an inner peripheral surface of the rotating cylindrical member is provided with an engaging surface which comes into contact with an outer peripheral surface of the zoom ring of the lens barrel to rotate the zoom ring integrally with the rotating cylindrical member.

7. The waterproof structure according to claim 1, wherein the relay mechanism of the locking/unlocking mechanism includes a first movable member interposed between the unlocking button and the lens barrel lock pin, and a second movable member interposed between the unlocking button and the case lock pin,
one end of the first movable member is integrally connected to the lens barrel lock pin, the other end of the first movable member is opposed to a first end of the unlocking button and is biased by the lens barrel lock pin and brought into contact, under pressure, with the first end of the unlocking button,
one end of the second movable member is integrally connected to the case lock pin, the other end of the second movable member is opposed to a second end of the unlocking button and is biased by the case lock pin and brought into contact, under pressure, with the second end of the unlocking button.

8. The waterproof structure according to claim 2, wherein the relay mechanism of the locking/unlocking mechanism includes a first movable member interposed between the unlocking button and the lens barrel lock pin, and a second movable member interposed between the unlocking button and the case lock pin,
one end of the first movable member is integrally connected to the lens barrel lock pin, the other end of the first movable member is opposed to a first end of the unlocking button and is biased by the lens barrel lock pin and brought into contact, under pressure, with the first end of the unlocking button,
one end of the second movable member is integrally connected to the case lock pin, the other end of the second movable member is opposed to a second end of the unlocking button and is biased by the case lock pin and brought into contact, under pressure, with the second end of the unlocking button.

9. The waterproof structure according to claim 3, wherein the relay mechanism of the locking/unlocking mechanism includes a first movable member interposed between the unlocking button and the lens barrel lock pin, and a second movable member interposed between the unlocking button and the case lock pin,
one end of the first movable member is integrally connected to the lens barrel lock pin, the other end of the first movable member is opposed to a first end of the unlocking button and is biased by the lens barrel lock pin and brought into contact, under pressure, with the first end of the unlocking button,
one end of the second movable member is integrally connected to the case lock pin, the other end of the second movable member is opposed to a second end of the unlocking button and is biased by the case lock pin and brought into contact, under pressure, with the second end of the unlocking button.

10. The waterproof structure according to claim 4, wherein the relay mechanism of the locking/unlocking mechanism includes a first movable member interposed between the unlocking button and the lens barrel lock pin, and a second movable member interposed between the unlocking button and the case lock pin,
one end of the first movable member is integrally connected to the lens barrel lock pin, the other end of the first movable member is opposed to a first end of the unlocking button and is biased by the lens barrel lock pin and brought into contact, under pressure, with the first end of the unlocking button,
one end of the second movable member is integrally connected to the case lock pin, the other end of the second movable member is opposed to a second end of the unlocking button and is biased by the case lock pin and brought into contact, under pressure, with the second end of the unlocking button.

11. The waterproof structure according to claim 5, wherein the relay mechanism of the locking/unlocking mechanism includes a first movable member interposed between the unlocking button and the lens barrel lock pin, and a second movable member interposed between the unlocking button and the case lock pin,
one end of the first movable member is integrally connected to the lens barrel lock pin, the other end of the first movable member is opposed to a first end of the unlocking button and is biased by the lens barrel lock pin and brought into contact, under pressure, with the first end of the unlocking button,
one end of the second movable member is integrally connected to the case lock pin, the other end of the second movable member is opposed to a second end of the unlocking button and is biased by the case lock pin and brought into contact, under pressure, with the second end of the unlocking button.

12. The waterproof structure according to claim 6, wherein the relay mechanism of the locking/unlocking mechanism includes a first movable member interposed between the unlocking button and the lens barrel lock pin, and a second movable member interposed between the unlocking button and the case lock pin,
one end of the first movable member is integrally connected to the lens barrel lock pin, the other end of the first movable member is opposed to a first end of the unlocking button and is biased by the lens barrel lock pin and brought into contact, under pressure, with the first end of the unlocking button,
one end of the second movable member is integrally connected to the case lock pin, the other end of the second movable member is opposed to a second end of the unlocking button and is biased by the case lock pin and brought into contact, under pressure, with the second end of the unlocking button.
